(19) United States
(12) Patent Application Publication
(10) Pub. No.: US 2017/0214184 A1
(43) Pub. Date: Jul. 27, 2017

(54) CONTACT TERMINAL, CONTACT SUPPORT, AND CONNECTION DEVICE INCLUDING SAME

(71) Applicants: YAMAICHI ELECTRONICS CO., LTD., Tokyo (JP); FUJITSU LIMITED, Kawasaki-shi (JP)

(72) Inventors: Yosuke TAKAI, Sakura-shi (JP); Toshiyasu ITO, Togane-shi (JP); Satoshi OHSAWA, Kawasaki-shi (JP)

(73) Assignees: YAMAICHI ELECTRONICS CO., LTD., Tokyo (JP); FUJITSU LIMITED, Kawasaki-shi (JP)

(21) Appl. No.: 15/409,071

(22) Filed: Jan. 18, 2017

(30) Foreign Application Priority Data
Jan. 22, 2016 (JP) 2016-010938

(51) Int. Cl. H01R 13/646; H01R 13/40; H01R 13/50; H01R 12/71; H01R 13/629

(52) U.S. Cl. CPC H01R 13/646; H01R 12/714; H01R 13/629; H01R 13/50; H01R 13/40; H01R 2107/00

(57) ABSTRACT

A contact unit includes signal and power-supply contact terminals, a first blade in which the contact terminals are nipped and held, and a second blade. In each contact terminal formed of a conductive metal material by using the MEMS technique, for example, a tapered portion of a short-circuit piece and a tapered portion of another short-circuit piece come into contact with each other when a pressure at a predetermined value or higher is applied to a first contact and a second contact in a direction to come close to each other.

### CROSS REFERENCES TO RELATED APPLICATION

This application claims the benefit of Japanese Patent Application No. 2016-010938, filed Jan. 22, 2016, which is hereby incorporated by reference herein in its entirety.

### BACKGROUND OF THE INVENTION

Field of the Invention

The present invention relates to a contact terminal, a contact support, and a connection device including the same.

Description of the Related Art

As disclosed in Japanese Patent Application Laid-Open No. 2004-335182, for example, a semiconductor device such as a central processing unit (CPU) formed by a LGA package is provided on a printed wiring board through amounting socket. Such mounting socket comprises, as its main components: a plurality of metal contact terminals which electrically connect the semiconductor device to the printed wiring board mentioned above; an alignment plate which aligns the plurality of contact terminals and positions lands of the semiconductor device relative to the contact terminals; a socket body which is fixed to the printed wiring board, and accommodates the alignment plate and the plurality of contact terminals; and a pressing cover member which presses the lands of the semiconductor device against the contact terminals.

In a quest to reduce inductance of a signal path, each of the above-described contact terminals comprises: a solder ball portion to be electrically connected to an electrode portion of the printed wiring board; a fixed side terminal portion having a coupling portion to be fixed by soldering to the solder ball portion; and a movable side terminal portion to be engaged with a pair of clips serving as an elastically deformable portion of the fixed side terminal portion molded by presswork. In such a configuration, when the semiconductor device placed in the alignment plate is pressed by the pressing cover member, a truncated conical portion of the movable side terminal portion comes closer to the solder ball portion whereby a total length of the corresponding signal path substantially becomes shorter, and inductance of the signal path to which a high-frequency band signal is supplied can be reduced as a consequence.

As for an electronic device which can switch high-frequency signals, an electronic device using the micro electro mechanical systems (MEMS) technique has been proposed as shown in Japanese Patent Application Laid-Open No. 2014-75193.

### SUMMARY OF THE INVENTION

The metal contact terminals obtained by the presswork has a limitation of durability against repeated displacement of the elastically deformable portion because it is difficult for the metal contact terminals to completely remove residual stress from the contact terminals. In addition, the frequency of the high-frequency band signal used in the semiconductor device such as the central processing unit (CPU), for example, tends to become higher in these days. Accordingly, there is a demand for further reduction in inductance of the signal path. Moreover, power consumption of the central processing unit (CPU) tends to increase, and as the socket body in the mounting socket as described above is formed by using a resin material and has a limitation in efficient dissipation of heat generated from the semiconductor device, during operation, it is not easy to keep the temperature of the heat-generating semiconductor device equal to or below a predetermined appropriate reference value.

In view of the above-described problems, an object of the present invention aims to provide a contact terminal, a contact support, and a connection device including the same. The contact terminal, the contact support, and the connection device including the same can reduce inductance of a signal path and improve durability against repeated displacement of an elastically deformable portion in the contact terminal, and efficiently dissipate generated heat.

To achieve the above-described the object, a contact terminal according to the present invention comprises: a first movable contact and a second movable contact movably provided while being opposed to each other on a common axial line, the contacts being configured to come into contact with electrodes of boards, respectively; an intermediate member provided between the first movable contact and the second movable contact; a first coupling portion including elastically deformable bend portions concatenated along the axial line and configured to couple the first movable contact to one end of the intermediate member; and a second coupling portion including elastically deformable bend portions concatenated along the axial line and configured to couple the second movable contact to another end of the intermediate member. The first movable contact, the second movable contact, the intermediate member, the first coupling portion, and the second coupling portion are provided integrally with one another. Here, when the first movable contact and the second movable contact are pressed so as to come closer to each other, a signal path is formed linearly between the first movable contact and the second movable contact by bringing the adjacent bend portions of the first coupling portion and the second coupling portion close to one another. The first coupling portion and the second coupling portion may be formed in two lines parallel to each other between the first movable contact and the second movable contact by using the MEMS technique.

In addition, a contact terminal according to another aspect of the present invention includes: a first movable contact and a second movable contact movably provided while being opposed to each other on a common axial line, the contacts being configured to come into contact with electrodes of boards, respectively; a pair of coupling portions each including elastically deformable bend portions connected along the axial line, and configured to couple the first movable contact to the second movable contact such that the first and second movable contacts can move toward and away from each other; a first short-circuit piece extending from an end of the first movable contact toward the second movable contact; and a second short-circuit piece extending from an end of the second movable contact toward the first movable contact. The first movable contact, the second movable contact, the coupling portions, the first short-circuit piece, and the second short-circuit piece are provided integrally with one another. When the first movable contact and the second movable contact are pressed so as to come closer to each other, a signal path is formed by the first movable contact, the second movable contact, the first short-circuit piece, and the second short-circuit piece by bringing the first short-circuit piece and the second short-circuit piece into contact with each other.

Moreover, a contact terminal according to another aspect of the present invention comprises: a first movable contact and a second movable contact movably provided while being opposed to each other on a common axial line, the contacts being configured to come into contact with electrodes of boards, respectively; a first coupling portion including elastically deformable bend portions connected along the axial line, and configured to couple the first movable contact to a first portion of a short-circuit piece opposed to the bend portions; and a second coupling portion including elastically deformable bend portions concatenated along the axial line, and configured to couple the second movable contact to a second portion of the short-circuit piece opposed to the bend portions. The first movable contact, the second movable contact, the first coupling portion, and the second coupling portion are provided integrally with one another. When the first movable contact and the second movable contact are pressed toward each other, a signal path is formed by the first movable contact, the second movable contact, and the short-circuit piece by bringing the short-circuit piece, any of the bend portions of the first coupling portion, and any of the curved portion of the second coupling portion into contact with one another.

Furthermore, a contact support according to an aspect of the present invention includes: a cell configured to individually house any of the above-described contact terminals. In addition, a contact support according to the present invention may include: recesses provided in one surface of the contact support and each configured to accommodate the above-described contact terminal; and recesses provided in another surface of the contact support opposite from the one surface and each configured to accommodate a contact terminal having a different shape from a shape of the aforementioned contact terminal.

A connection device according to the present invention comprises: the above-described contact terminals; the above-described contact supports; and a casing formed of a metal material and configured to accommodate the contact supports.

According to the contact terminal, the contact support, and the connection device including the same of the present invention, when the first movable contact and the second movable contact are pressed toward each other, the signal path is formed linearly between the first movable contact and the second movable contact by bringing the adjacent bend portions of the first coupling portion and the second coupling portion close to one another. Thus, inductance of the signal path can be reduced. In addition, when each contact terminal is formed on the basis of the MEMS technique, for example, it is possible to improve durability of each elastically deformable portion of the contact terminal against repeated displacement, and moreover, to efficiently dissipate heat generated therefrom.

Further features of the present invention will become apparent from the following description of exemplary embodiments (with reference to the attached drawings).

### BRIEF DESCRIPTION OF THE DRAWINGS

FIG. 1 is an enlarged plan view showing a first embodiment of a contact terminal according to the present invention;

FIG. 2 is a perspective view showing an example of a connection device according to the present invention together with a printed wiring board;

FIG. 3 is a partial cross-sectional view showing the example illustrated in FIG. 1 with the contact terminal being accommodated in a blade;

FIG. 4A is a perspective view showing one surface of a blade used in the example illustrated in FIG. 2;

FIG. 4B is a perspective view showing another surface of the blade;

FIG. 5 is an enlarged plan view showing a second embodiment of a contact terminal according to the present invention;

FIG. 6 is a partial cross-sectional view showing the example illustrated in FIG. 5 with the contact terminal being housed in a blade;

FIG. 7 is a partial enlarged diagram made available for explaining an operation of the example illustrated in FIG. 5;

FIG. 8 is a plan view showing a contact sheet of a contact terminal representing a third embodiment of a contact terminal according to the present invention;

FIG. 9A is a perspective view showing a blade to which one contact sheet illustrated in FIG. 8 is mounted;

FIG. 9B is a perspective view showing the blade to which a plurality of contact sheets illustrated in FIG. 8 are mounted;

FIG. 10 is a perspective view showing a fourth embodiment of a contact terminal according to the present invention;

FIG. 11A is a perspective view showing part of a blade to which contact terminals illustrated in FIG. 10 are mounted;

FIG. 11B is a perspective view showing part of another blade to which the contact terminals illustrated in FIG. 10 are mounted;

FIG. 12 is a perspective view showing external appearance of another example of the connection device according to the present invention together with a printed wiring board;

FIG. 13 is a perspective view showing a state of detaching a contact unit from a casing in the example illustrated in FIG. 12;

FIG. 14 is a perspective view showing a state in which a fifth embodiment of contact terminals according to the present invention are mounted to a blade;

FIG. 15 is a perspective view showing a state in which the fifth embodiment of the contact terminals according to the present invention are mounted to a blade provided with a carrier;

FIG. 16 is a perspective view showing the fifth embodiment of a contact terminal according to the present invention;

FIG. 17 is a plan view of the example illustrated in FIG. 16;

FIG. 18 is a partial enlarged diagram showing an enlarged part of the example illustrated in FIG. 17;

FIG. 19 is a plan view made for explaining an operation of the example illustrated in FIG. 16;

FIG. 20 is a partial enlarged diagram showing an enlarged part of the example illustrated in FIG. 19;

FIG. 21 is a side view of the example in FIG. 20;

FIG. 22A is a perspective view showing a sixth embodiment of a contact terminal according to the present invention; and

FIG. 22B is a perspective view showing the sixth embodiment of the contact terminal according to the present invention.

### DESCRIPTION OF THE EMBODIMENTS

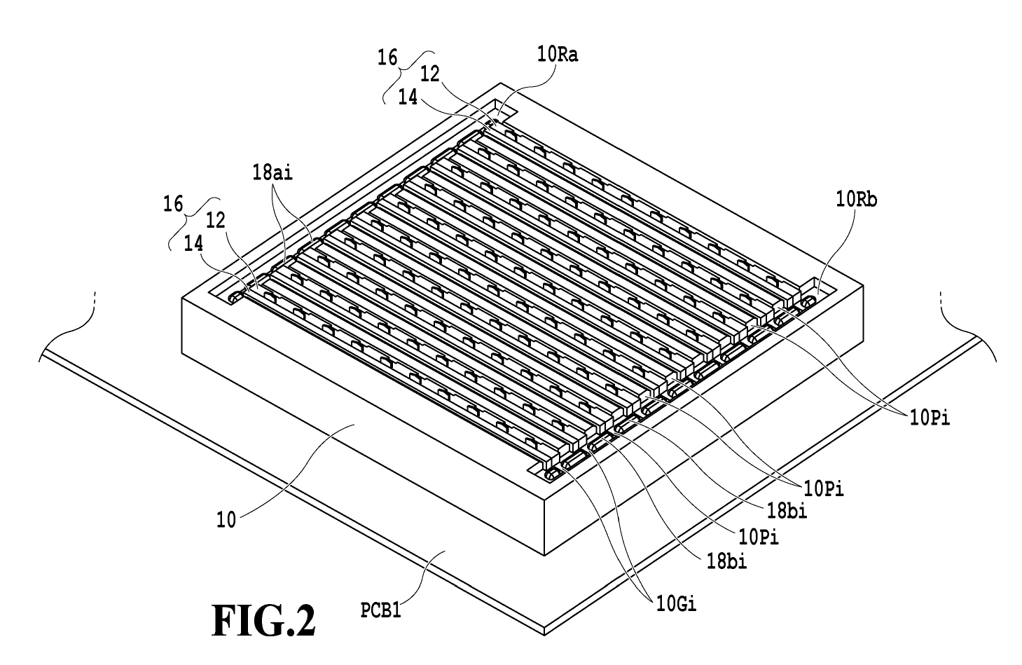

FIG. 2 shows external appearance of an example of a connection device to which each embodiment of contact terminals of the present invention is applied.

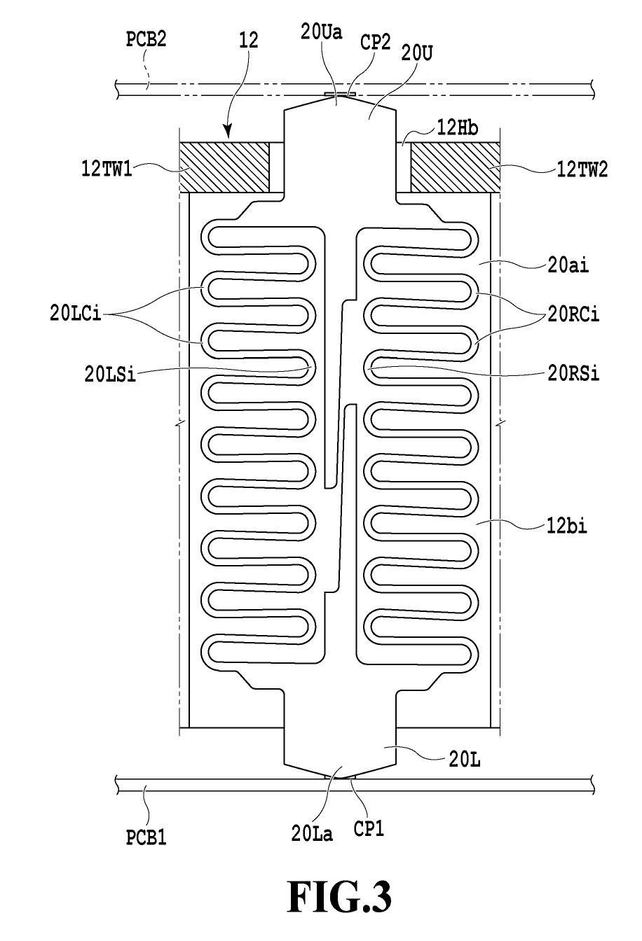

In FIG. 2, the connection device is a board-to-board connector, for example, which electrically connects electrodes of a printed wiring board PCB1 to electrodes of a printed wiring board PCB2 (see FIG. 3), the printed wiring boards being opposed to each other.

The connection device comprises, as its main components: a casing 10 provided with a plurality of slits 10Gi (i=1 to n, n is a positive integer) arranged at predetermined intervals and designed to accommodate blades each serving as a contact support to be described later; and contact units to be inserted into the slits 10Gi in the casing 10, respectively.

The casing 10 is formed from a metal material, for example, and has partition walls 10Pi (i=1 to n, n is a positive integer) located between the adjacent slits 10Gi. Hereby, the adjacent slits 10Gi are partitioned by the partition walls 10Pi The slits 10Gi penetrate the casing 10 and are open to surfaces of the printed wiring boards PCB1 and PCB2. At an end of the casing 10 opposed to the printed wiring board PCB2, a recess 10Ra and a recess 10Rb are formed at both ends of the partition walls 10Pi, respectively. Each of the recess 10Ra and the recess 10Rb extends in an arrangement direction of the slits 10Gi.

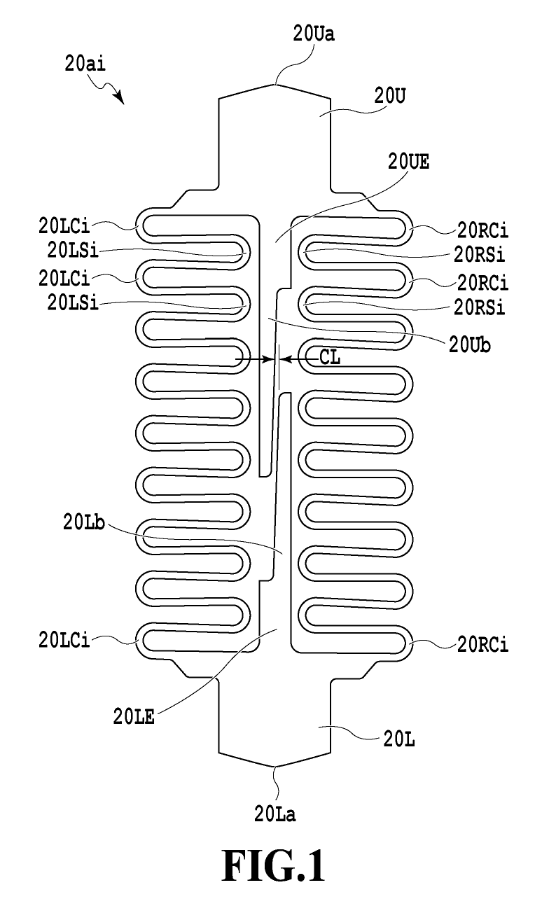

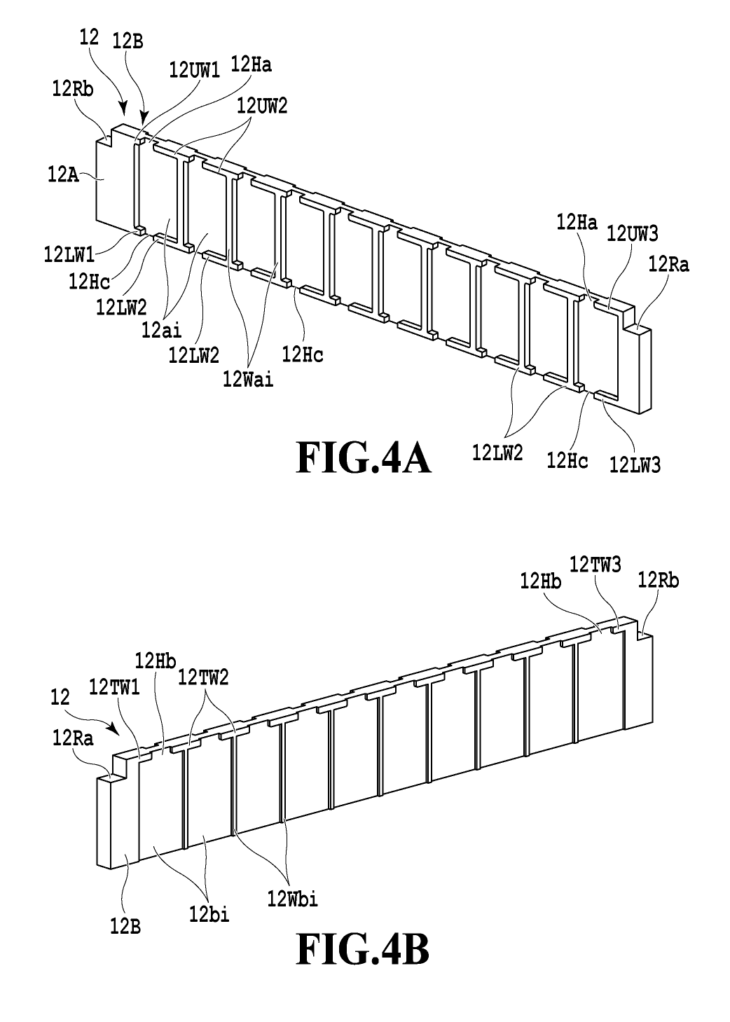

Contact unit 16 comprises a plurality of signal and power-supply contact terminals 20ai (i=1 to n, n is a positive integer) as shown in the enlarged view of FIG. 1, a first blade 12 (see FIGS. 4A and 4B) in which the contact terminals 20ai are nipped and accommodated, and a second blade 14.

Contact terminal 20ai representing a first embodiment of a contact terminal according to the present invention is formed from a conductive metal material by using the MEMS technique, for example. The contact terminal 20ai comprises a first contact 20L to come into contact with an electrode CP1 of the printed wiring board PCB1, a second contact 20U to come into contact with an electrode CP2 of the printed wiring board PCB2, and a pair of coupling portions to couple the first contact 20L to the second contact 20U such that the first contact 20L and the second contact 20U can come closer and away from each other.

The first contact 20L comprises: a cusped portion provided with a touching portion 20La that comes into contact with the electrode CP1 of the printed wiring board PCB1; a short-circuit piece 20LE integrally formed at the center of an end opposite from the touching portion 20La of the cusped portion; and an extended portion coupled to respective ends of the pair of coupling portions to be described later. The short-circuit piece 20LE has a tapered portion 20Lb which extends toward a short-circuit piece 20UE of the second contact 20U. One side of the tapered portion 20Lb has a predetermined inclination.

The second contact 20U comprises: a cusped portion provided with a touching portion 20Ua that comes into contact with the electrode CP2 of the printed wiring board PCB2; a short-circuit piece 20UE integrally formed at the center of an end opposite from the touching portion 20Ua of the cusped portion; and an extended portion coupled to respective ends of the pair of coupling portions to be described later. The short-circuit piece 20UE has a tapered portion 20Ub which extends toward the short-circuit piece 20LE of the first contact 20L. One side of the tapered portion 20Ub opposed to the one side of the tapered portion 20Lb mentioned above has a predetermined inclination. When a pressure is not applied to the first contact 20L and the second contact 20U in a direction to come close to each other, a predetermined clearance CL is defined between the tapered portion 20Lb and the tapered portion 20Ub as shown in the enlarged view of FIGS. 1 and 3. On the other hand, when the pressure is applied to the first contact 20L and the second contact 20U in a direction to come close to each other, the tapered portion 20Lb and the tapered portion 20Ub are brought into contact with each other.

The pair of coupling portions are formed, respectively, on both sides of the short-circuit piece 20LE and the short-circuit piece 20UE and on the common plane. In FIG. 1, one of the coupling portions formed on the right side of the short-circuit piece 20LE and the short-circuit piece 20UE comprises a plurality of bend portions 20RSi (i=1 to n, n is a positive integer) that are convexly curved in such a way as to protrude toward the short-circuit piece 20LE and the short-circuit piece 20UE, and a plurality of arcuate portions 20RCi (i=1 to n, n is a positive integer) each of which couples ends of the adjacent bend portions 20RSi to each other or couples an end of the curved portion 20RSi to an end of the corresponding extended portion. The bend portions 20RSi and the arcuate portions 20RCi are continuously connected on the common plane, whereby the one coupling portion is formed to be elastically deformable in a moving direction of the first contact 20L and the second contact 20U. In addition, the other coupling portion comprises a plurality of bend portions 20LSi (i=1 to n, n is a positive integer) that are convexly curved in such a way as to protrude toward the short-circuit piece 20LE and the short-circuit piece 20UE, and a plurality of arcuate portions 20LCi (i=1 to n, n is a positive integer) each of which couples ends of the adjacent bend portions 20LSi to each other or couples an end of the bend portion 20LSi to the corresponding extended portion. The bend portions 20LSi and the arcuate portions 20LCi are continuously connected on the common plane, whereby the other coupling portion is formed to be elastically deformable in the moving direction of the first contact 20L and the second contact 20U. Hereby, the pair of coupling portions are made expandable and contractible in the moving direction of the first contact 20L and the second contact 20U.

As shown in the enlarged view of FIG. 3, each of the contact terminals 20ai is individually accommodated in each of recesses 12bi (i=1 to n, n is a positive integer) in the first blade 12.

As shown in the enlarged view of FIGS. 4A and 4B, the first blade 12 is formed into a thin plate by using a resin material, for example. A plurality of relatively shallow recesses 12bi are formed in one surface 12B of the first blade 12. The adjacent recesses 12bi are partitioned therebetween by partition walls 12wbi (i=1 to n, n is a positive integer) that are formed in parallel to one another. One end of each partition wall 12wbi crosses an upper edge portion 12TW2 of the blade 12. In FIG. 4B, a hole 12Hb from which the second contact 20U inserted therein protrudes to the outside is formed between the adjacent upper edge portions 12TW2. A hole 12Hb is formed at a recess 12bi on the left end and between the upper edge portion 12TW2 and another upper edge portion 12TW1. Moreover, a hole 12Hb is formed at a recess 12bi on the right end and between the upper edge portion 12TW2 and another upper edge portion 12TW3. A lower end of each recess 12bi is open.

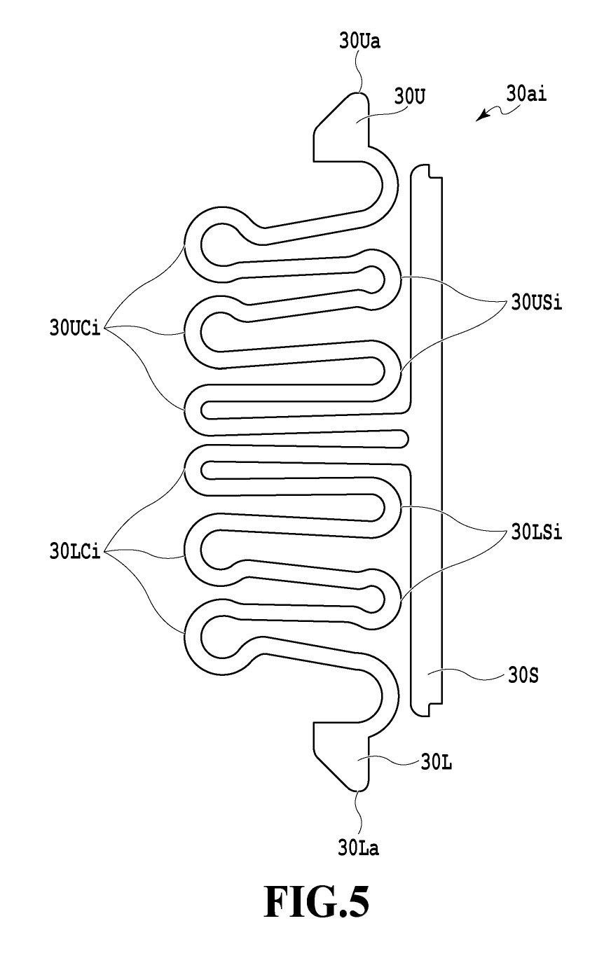

In addition, as shown in FIG. 4A, a plurality of relatively shallow recesses 12ai (i=1 to n, n is a positive integer) are formed in another surface 12A of the first blade 12. A contact terminal 30ai (see FIG. 5) to be described later is accommodated in each of the recesses 12ai. The adjacent recesses 12ai are partitioned therebetween by partition walls 12wai (i=1 to n, n is a positive integer) that are formed in parallel to one another. One end of each partition wall 12wai crosses an upper edge portion 12UW2 of the blade 12. The other end of the partition wall 12wai crosses a lower edge portion 12LW2. In FIG. 4A, a hole 12Ha from which a second contact 30U described later inserted therein protrudes to the outside is formed between the adjacent upper edge portions 12UW2. The hole 12Ha is formed at a position displaced to one side relative to the center axis of the recess 12ai. A hole 12Ha is formed at a recess 12ai on the left end and between the upper edge portion 12UW2 and another upper edge portion 12UW1. Moreover, a hole 12Ha is also formed at a recess 12ai on the right end and between the upper edge portion 12UW2 and another upper edge portion 12UW3.

A hole 12Hc from which a first contact 30L described later inserted therein protrudes to the outside is formed between the adjacent lower edge portions 12LW2. The hole 12Hc is formed at a position displaced to one side relative to the center axis of the recess 12ai and opposed to the above-mentioned hole 12Ha. A hole 12Hc is formed at the recess 12ai on the left end and between the lower edge portion 12LW2 and another lower edge portion 12LW1. Moreover, a hole 12Hc is also formed at the recess 12ai on the right end and between the lower edge portion 12LW2 and another lower edge portion 12LW3.

Although detailed illustration for the second blade 14 is omitted, the second blade 14 is formed into a thin plate by using a resin material, for example. The second blade 14 has a flat surface, which comes into contact with a flat surface of each of the contact terminals 20ai and the contact terminals 30ai, and sandwiches the contact terminals in conjunction with the above-described first blade 12 to be opposed thereto.

Each contact unit 16 is inserted into the corresponding slit 10Gi of the casing 10 in the state of sandwiching the contact terminals 20ai between the first blade 12 and the second blade 14. Then, ends on both sides of the first blade 12 and the second blade 14 are welded to bottom portions of the casing 10 forming the recesses 10Ra and 10Rb. Herewith, respective welded portions 18ai and 18bi are formed on the both sides of each contact unit 16. The present invention is not limited to the above-mentioned example. For instance, the both ends of the first blade 12 and of the second blade 14 may be fixed by using an adhesive.

In this configuration, the casing 10 to which the contact units 16 are fixed is located between the electrodes of the printed wiring boards PCB1 and PCB2 as shown in FIG. 3. Thereafter, machine screws (not shown) are threaded into female screw holes (not shown) provided in two end surfaces of the casing 10, for example, via through-holes in the printed wiring boards PCB1 and PCB2. Then, the first contact 20L and the second contact 20U of each contact terminal 20ai are moved closer each other by a predetermined distance while being pressed by the electrodes of the printed wiring boards PCB1 and PCB2 against elastic force of the pair of coupling portions of the contact terminal 20ai. Hereby, the short-circuit piece 20LE and the short-circuit piece 20UE come into contact with each other, whereby a signal path is formed by the first contact 20L, the short-circuit piece 20LE, the short-circuit piece 20UE, and the second contact 20U. Accordingly, a total length of the signal path becomes relatively shorter, and inductance of the contact terminal 20ai is reduced as a consequence. Moreover, each contact terminal 20ai is formed into a fine and relatively thin shape by using the conductive metal material and the MEMS technique. As a consequence, the contact terminals 20ai have no residual stress but have excellent durability against repeated displacement.

FIG. 5 shows another example of signal and power-supply contact terminals used in the connection device illustrated in FIG. 2.

In FIG. 5, each contact terminal 30ai (i=1 to n, n is a positive integer) representing a second embodiment of a contact terminal according to the present invention is formed from a conductive metal material by using the MEMS technique, for example. The contact terminal 30ai comprises the first contact 30L to come into contact with the electrode CP1 of the printed wiring board PCB1, the second contact 30U to come into contact with the electrode CP2 of the printed wiring board PCB2, a first elastic support piece movably supporting the first contact 30L, a second elastic support piece movably supporting the second contact 30U, and a short-circuit piece 30S to support one end of the first elastic support piece and one end of the second elastic support piece while aligning the elastic support pieces in parallel to each other.

The first contact 30L has a cusped portion provided with a touching portion 30La that comes into contact with the electrode CP1 of the printed wiring board PCB1. The second contact 30U has a cusped portion provided with a touching portion 30Ua that comes into contact with the electrode CP2 of the printed wiring board PCB2.

The first elastic support piece comprises a plurality of bend portions 30LSi (i=1 to n, n is a positive integer) that are convexly curved in such a way as to protrude toward the short-circuit piece 30S, and a plurality of arcuate portions 30LCi (i=1 to n, n is a positive integer). The bend portions 30LSi and the arcuate portions 30LCi are continuously connected on the common plane, whereby the bend portions 30LSi and arcuate portions 30LCi are formed to be elastically deformable in a moving direction of the first contact 30L. The plurality of the arcuate portions 30LCi couples ends of the adjacent bend portions 30LSi to each other or couples an end of the bend portion 30LSi to a coupling end of the first contact 30L or to a coupling end of the short-circuit piece 30S, respectively.

The second elastic support piece comprises a plurality of bend portions 30USi (i=1 to n, n is a positive integer) that are convexly curved in such a way as to protrude toward the short-circuit piece 30S, and a plurality of arcuate portions 30UCi (i=1 to n, n is a positive integer). The bend portions 30USi and the arcuate portions 30UCi are continuously connected on the common plane, whereby the bend portions 30USi and the arcuate portions 30UCi are formed to be elastically deformable in a moving direction of the second contact 30U. The plurality of the arcuate portions 30UCi couples ends of the adjacent bend portions 30USi to each other or couples an end of bend portion 30USi to a coupling end of the second contact 30U or to a coupling end of the short-circuit piece 30S.

The short-circuit piece 30S is formed in a direction substantially parallel to an arrangement direction of the bend portions 30LSi of the first elastic support piece and of the bend portions 30USi of the second elastic support piece, and in a direction substantially perpendicular to the above-mentioned coupling ends.

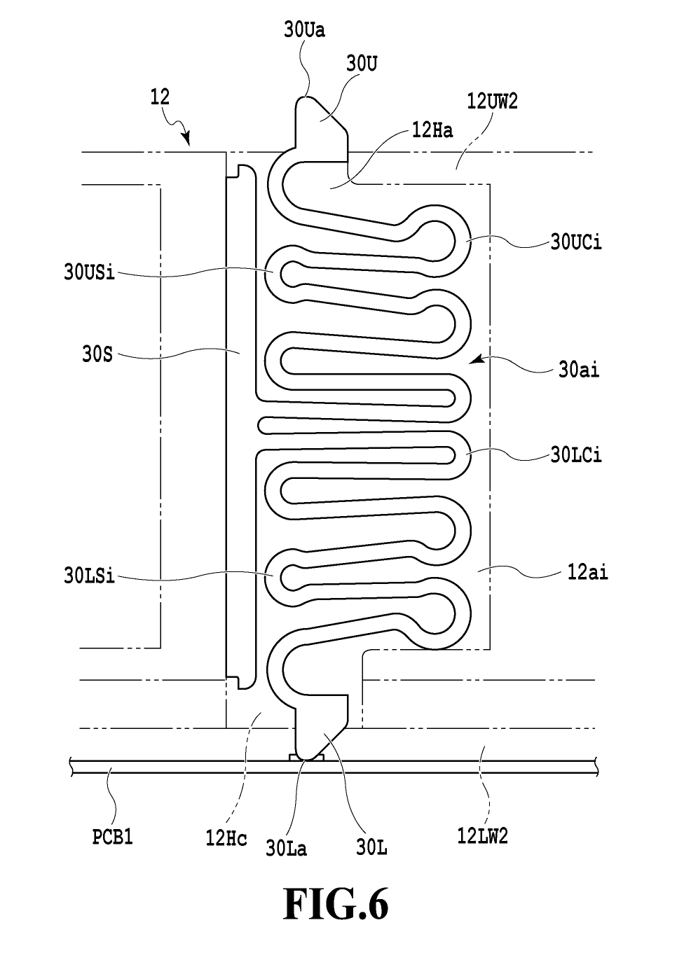

As shown in the enlarged view of FIG. 6, each of the contact terminals 30ai is individually accommodated in each of the recesses 12ai in the first blade 12 mentioned above. At that time, the second contact 30U protrudes outward through the hole 12Ha, and the first contact 30L protrudes outward through the hole 12Hc. The short-circuit piece 30S is supported by an inner peripheral surface that defines the recess 12ai.

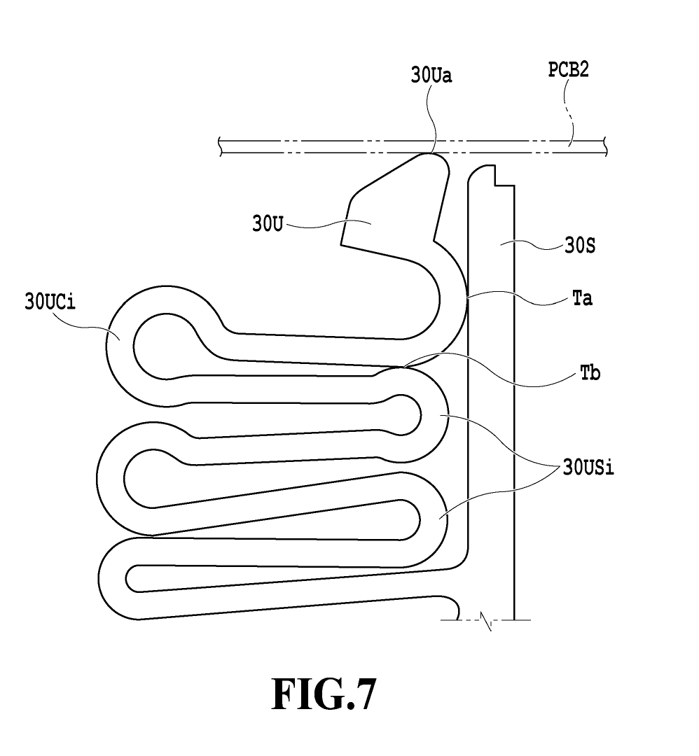

In the above-described configuration, as with the aforementioned example, the first contact 30L and the second contact 30U of each contact terminal 30ai are moved closer to each other by a predetermined distance while being pressed by the electrodes of the printed wiring boards PCB1 and PCB2 against elastic force of the first elastic support piece and the second elastic support piece. In this case, as shown in the partial enlarged view of FIG. 7, the coupling ends of the first contact 30L and the second contact 30U connected to the arcuate portion 30LCi and the arcuate portion 30UCi are moved toward the short-circuit piece 30S, respectively, and are brought into contact with the short-circuit piece 30S at predetermined contact positions Ta and then follow the short-circuit piece 30S. Thereafter, the coupling ends are brought into contact with the corresponding the bend portion 30USi at contact position Tb. Hereby, a signal path is formed by the first contact 30L, the short-circuit piece 30S, and the second contact 30U. Accordingly, a total length of the signal path becomes relatively shorter, and inductance of the contact terminal 30ai is reduced as a consequence.

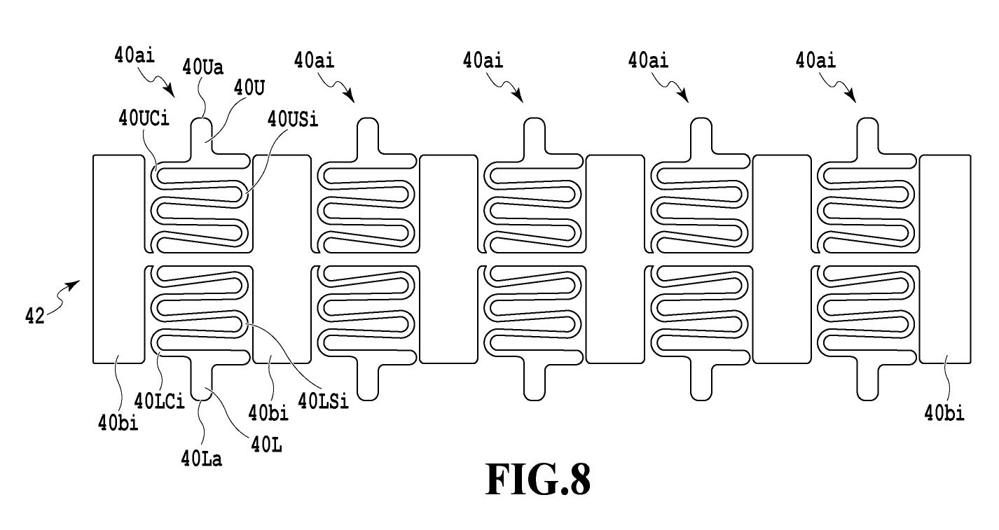

FIG. 8 enlargedly shows an example of a power-supply contact sheet, which is to be used in the connection device illustrated in FIG. 2.

A power-supply contact sheet 42 having a plurality of contact terminals 40ai, each of which represents a third embodiment of a contact terminal according to the present invention, is integrally formed into a thin plate by using a conductive metal material and the MEMS technique, for example. The power-supply contact sheet 42 comprises the plurality of contact terminals 40ai (i=1 to n, n is a positive integer), and coupling pieces 40bi (i=1 to n, n is a positive integer) which couple the plurality of contact terminals 40ai in such a way as to be in parallel to one another. Hereby, a contact unit comprises the power-supply contact sheet 42, a first blade 15 in which the power-supply contact sheet 42 is nipped and accommodated, and a second blade (not shown) opposed to the first blade 15.

The coupling pieces 40bi are formed in spaces between the adjacent contact terminals 40ai and at both ends of the power-supply contact sheet 42. The coupling pieces 40bi are formed integrally with intermediate support pieces of the contact terminals 40ai to be described later and in such a way as to be intersected by the intermediate support pieces at right angles.

Each contact terminal 40ai of the power-supply contact sheet 42 comprises a first contact 40L to come into contact with the electrode CP1 of the printed wiring board PCB1 described above, a second contact 40U to come into contact with the electrode CP2 of the printed wiring board PCB2 described above, a first elastic support piece movably supporting the first contact 40L, a second elastic support piece movably supporting the second contact 40U, and the intermediate support piece formed integrally with the coupling piece 40bi and supporting one end of the first elastic support piece and one end of the second elastic support piece in such a way as to be in parallel to each other.

The first contact 40L has a projection provided with an arc-shaped touching portion 40La that comes into contact with the electrode CP1 of the printed wiring board PCB1. The second contact 40U has a projection provided with an arc-shaped touching portion 40Ua that comes into contact with the electrode CP2 of the printed wiring board PCB2.

The first elastic support piece comprises a plurality of bend portions 40LSi (i=1 to n, n is a positive integer) that are convexly curved in such a way as to protrude toward the coupling piece 40bi, and a plurality of arcuate portions 40LCi (i=1 to n, n is a positive integer) each of which couples ends of the adjacent bend portions 40LSi to each other or couples an end of the bend portion 40LSi to a coupling end of the first contact 40L or to the intermediate support piece. The bend portions 40LSi and the arcuate portions 40LCi are continuously connected on the common plane, whereby the bend portions 40LSi and the arcuate portions 40LCi are formed to be elastically deformable in a moving direction of the first contact 40L.

The second elastic support piece comprises a plurality of bend portions 40USi (i=1 to n, n is a positive integer) that are convexly curved in such a way as to protrude toward the coupling piece 40bi, and a plurality of arcuate portions 40UCi (i=1 to n, n is a positive integer) each of which couples ends of the adjacent bend portions 40USi to each other or couples an end of the bend portion 40USi to a coupling end of the second contact 40U or to the intermediate support piece. The bend portions 40USi and the arcuate portions 40UCi are continuously connected on the common plane, whereby the bend portions 40USi and the arcuate portions 40UCi are formed to be elastically deformable in a moving direction of the second contact 40U.

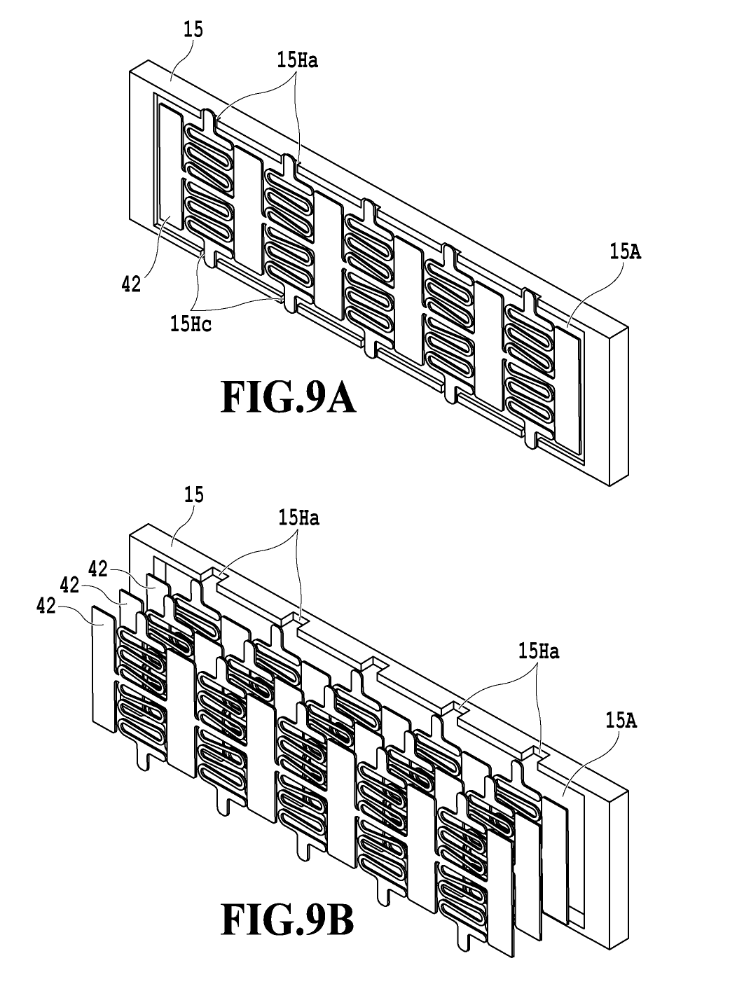

As shown in the enlarged view of FIG. 9A, the first blade 15 is formed into a thin plate by using a resin material, for example. A relatively shallow recess 12A, into which one or more power-supply contact sheets 42 are to be accommodated, is formed in one surface of the first blade 15. Holes 15Ha and 15Hc from which the projections of the first contacts 40L and the projections of the second contacts 40U inserted therein protrude to the outside are formed, respectively, in an upper edge portion and a lower edge portion that define the recess 15A.

The second blade (not shown) is formed into a thin plate by using a resin material, for example. The second blade has a pressing surface, which comes into contact with the coupling pieces 40bi of the power-supply contact sheet 42 and presses the coupling pieces 40bi.

Note that the number of the power-supply contact sheets 42 is not limited to the aforementioned example. As shown in FIG. 9B, three power-supply contact sheets 42 may be stacked and accommodated, for instance. Accordingly, a current capacity of a power-supply line is increased by stacking the three power-supply contact sheets 42.

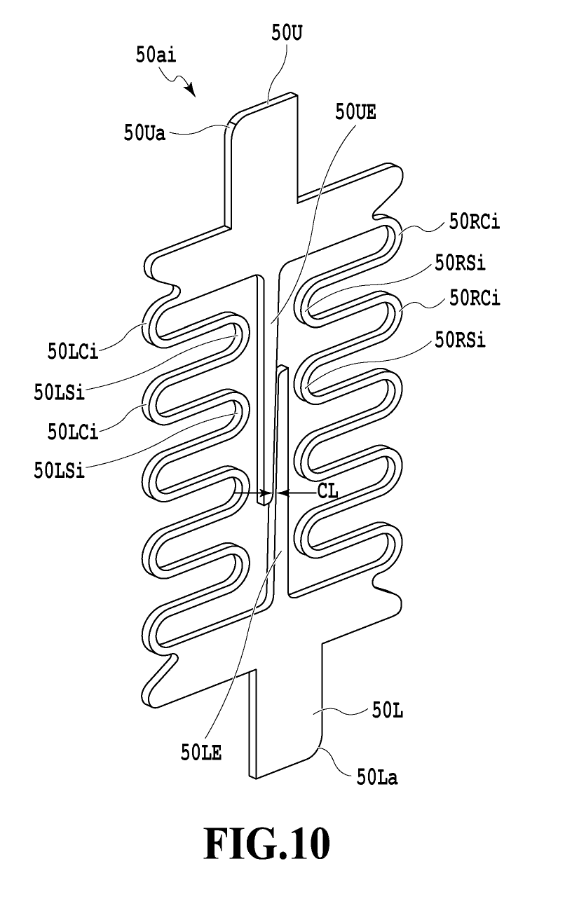

FIG. 10 enlargedly shows still another example of signal and power-supply contact terminals, which are to be used in the connection device illustrated in FIG. 2.

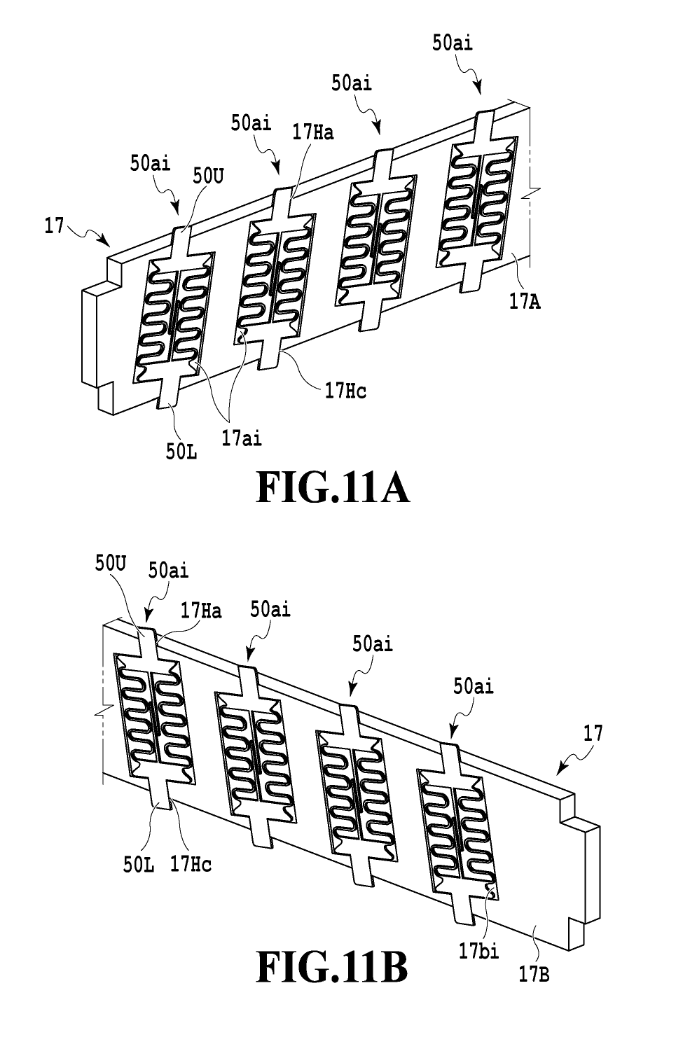

Contact terminals 50ai, each of which represents a fourth embodiment of a contact terminal according to the present invention, are integrally formed by using a conductive metal material and the MEMS technique, for example. Each contact terminal 50ai comprises a first contact 50L to come into contact with the electrode CP1 of the printed wiring board PCB1 described above, a second contact 50U to come into contact with the electrode CP2 of the printed wiring board PCB2 described above, and a pair of coupling portions to couple the first contact 50L to the second contact 50U such that the first contact 50L and the second contact 50U can move toward and away from each other. Hereby, a contact unit comprises the plurality of contact terminals 50ai, a blade 17 (see FIG. 11A) which accommodates the contact terminals 50ai into recesses 17ai (i=1 to n, n is a positive integer) formed in one surface 17A thereof, and the blade 17 (see FIG. 11B) which is opposed to the one surface of the former blade 17, and accommodates the contact terminals 50ai into recesses 17bi (i=1 to n, n is a positive integer) formed in another surface 17B thereof.

The first contact 50L comprises: a projection provided with an arc-shaped touching portion 50La, which is located at a corner of a tip end of the first contact 50L and comes into contact with the electrode CP1 of the printed wiring board PCB1; a extended portion continuous to the projection and coupled, respectively, to a pair of coupling portions to be described later; and a short-circuit piece 50LE integrally formed at the center of the extended portion on the opposite side from the projection. The short-circuit piece 50LE extends toward a short-circuit piece 50UE of the second contact 50U. One side of the short-circuit piece 50LE has a predetermined inclination.

The second contact 50U comprises: a projection provided with an arc-shaped touching portion 50Ua, which is located at a corner of a tip end of the second contact 50U and comes into contact with the electrode CP2 of the printed wiring board PCB2; an extended portion continuous to the projection and coupled, respectively, to the pair of coupling portions to be described later; and the short-circuit piece 50UE integrally formed at the center of the extended portion on the opposite side from the projection. The touching portion 50Ua is located opposite from the above-described touching portion 50La along a straight line that crosses the center axis of the contact terminal 50ai at a predetermined angle.

The short-circuit piece 50UE extends toward the short-circuit piece 50LE of the first contact 50L. A side on one side surface of the short-circuit piece 50UE, which is opposed to the side surface of the short-circuit piece 50LE having the predetermined inclination, has a predetermined inclination. When a pressure is not applied to the first contact 50L and the second contact 50U in a direction to come close to each other, a predetermined clearance CL is defined between the short-circuit piece 50UE and the short-circuit piece 50LE. On the other hand, when the pressure more than a predetermined value is applied to the first contact 50L and the second contact 50U in a direction to come close to each other, the short-circuit piece 50UE and the short-circuit piece 50LE are brought into contact with each other.

The pair of coupling portions are formed on both sides of the short-circuit piece 50LE and the short-circuit piece 50UE, respectively. In FIG. 10, one of the coupling portions formed on the right side of the short-circuit piece 50LE and the short-circuit piece 50UE comprises a plurality of bend portions 50RSi (i=1 to n, n is a positive integer) that are convexly curved in such a way as to protrude toward the short-circuit piece 50LE and the short-circuit piece 50UE, and a plurality of arcuate portions 50RCi (i=1 to n, n is a positive integer) each of which couples ends of the adjacent bend portions 50RSi to each other or couples an end of the bend portion 50RSi to an end of the corresponding extended portion. The bend portions 50RSi and the arcuate portions 50RCi are continuously connected on the common plane, whereby the bend portions 50RSi and arcuate portions 50RCi are formed to be elastically deformable in a moving direction of the first contact 50L and the second contact 50U. In addition, the other coupling portion comprises a plurality of bend portions 50LSi (i=1 to n, n is a positive integer) that are convexly curved in such a way as to protrude toward the short-circuit piece 50LE and the short-circuit piece 50UE, and a plurality of arcuate portions 50LCi (i=1 to n, n is a positive integer) each of which couples ends of the adjacent bend portions 50LSi to each other or couples an end of the bend portion 50LSi to the corresponding extended portion. The bend portions 50LSi and the arcuate portions 50LCi are continuously connected on the common plane, whereby the bend portions 50LSi and the arcuate portions 50LCi are formed to be elastically deformable in the moving direction of the first contact 50L and the second contact 50U. Hereby, the pair of coupling portions are made expandable and contractible in the moving direction of the first contact 50L and the second contact 50U.

As shown in FIGS. 11A and 11B, each of the contact terminals 50ai is individually accommodated in each of recesses 17ai in the blade 17 and each of recesses 17bi (i=1 to n, n is a positive integer) in the blade 17.

When the contact terminals 50ai to be accommodated in the blade 17 are used as the signal contact terminals, the blade 17 is formed into a thin plate by using a resin material, for example. On the other hand, when the contact terminals 50ai to be accommodated in the blade 17 are used as the power-supply contact terminals, the blade 17 is formed into a thin plate by using an aluminum alloy or a copper alloy, for example. In the latter case, heat dissipation efficiency of the connection device can be improved since the casing 10 is also formed from the metal material.

As shown in FIG. 11B, a plurality of relatively shallow recesses 17bi are formed in parallel to one another in one surface 17B of the blade 17. Each recess 17bi is formed in such a way as to be inclined from the upper left to the lower right with its center axis crossing an upper edge portion and a lower edge portion of the blade 17 at a predetermined angle. The adjacent recesses 17bi are partitioned therebetween by partition walls and are thus separated from one another. In FIG. 11B, holes 17Ha from which the second contacts 50U inserted therein protrude to the outside are formed in the upper edge portion of the blade 17 at locations immediately above the recesses 17bi. Holes 17Hc are open in the lower edge portion of the blade 17 at locations immediately below the recesses 17bi.

In addition, as shown in FIG. 11A, a plurality of relatively shallow recesses 17ai (i=1 to n, n is a positive integer) are formed in another surface 17A of the blade 17. The contact terminals 50ai are accommodated in the recesses 17ai, respectively. Each recess 17ai is formed in such a way as to be inclined from the upper right to the lower left with its center axis crossing the upper edge portion and the lower edge portion of the blade 17 at a predetermined angle. The adjacent recesses 17ai are partitioned therebetween by partition walls and are thus separated from one another. In FIG. 11A, the holes 17Ha from which the second contacts 50U inserted therein protrude to the outside are formed in the upper edge portion of the blade 17 at locations immediately above the recesses 17ai. The holes 17Hc are open in the lower edge portion of the blade 17 at locations immediately below the recesses 17ai.

Herewith, by stacking the first blade 17 and the second blade 17 to be opposed to the one surface 17A of the first blade 17, the contact terminals 50ai are sandwiched between the two blades 17 in such a state that two contact terminals 50ai are stacked on each other. As a consequence, a current capacity is increased.

In this configuration, the casing 10 to which the contact units are fixed is located between the electrodes of the printed wiring boards PCB1 and PCB2. Thereafter, machine screws (not shown) are threaded into female screw holes (not shown) provided in two end surfaces of the casing 10, for example, via through-holes in the printed wiring boards PCB1 and PCB2. Then, the first contact 50L and the second contact 50U of each contact terminal 50ai are moved closer to each other by a predetermined distance while being pressed by the electrodes of the printed wiring boards PCB1 and PCB2 against elastic force of the pair of coupling portions of the contact terminal 50ai. Herewith, the short-circuit piece 50LE and the short-circuit piece 50UE come into contact with each other, whereby a signal path is formed by the first contact 50L, the short-circuit piece 50LE, the short-circuit piece 50UE, and the second contact 50U. Accordingly, a total length of the signal path becomes relatively shorter, and inductance of the contact terminal 50ai is reduced as a consequence. At that time, there is obtained a wiping effect on the electrodes by the touching portions 50La and 50Ua of the first contact 50L and the second contact 50U.

Moreover, each contact terminal 50ai is formed into a fine and relatively thin shape by using the conductive metal material and the MEMS technique. As a consequence, the contact terminals 50ai have no residual stress, and have excellent durability against repeated displacement.

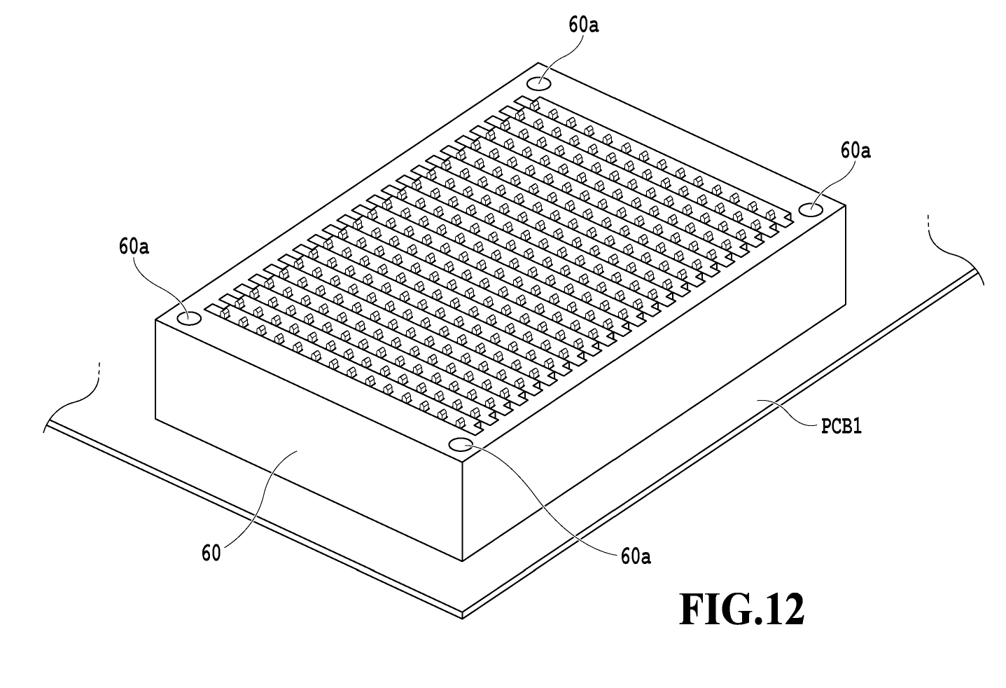

FIG. 12 shows external appearance of another example of the connection device according to the present invention.

In FIG. 12, the connection device is a board-to-board connector, for example, which electrically connects the electrodes of the printed wiring board PCB1 to electrodes of another printed wiring board (not shown), the printed wiring boards being opposed to each other.

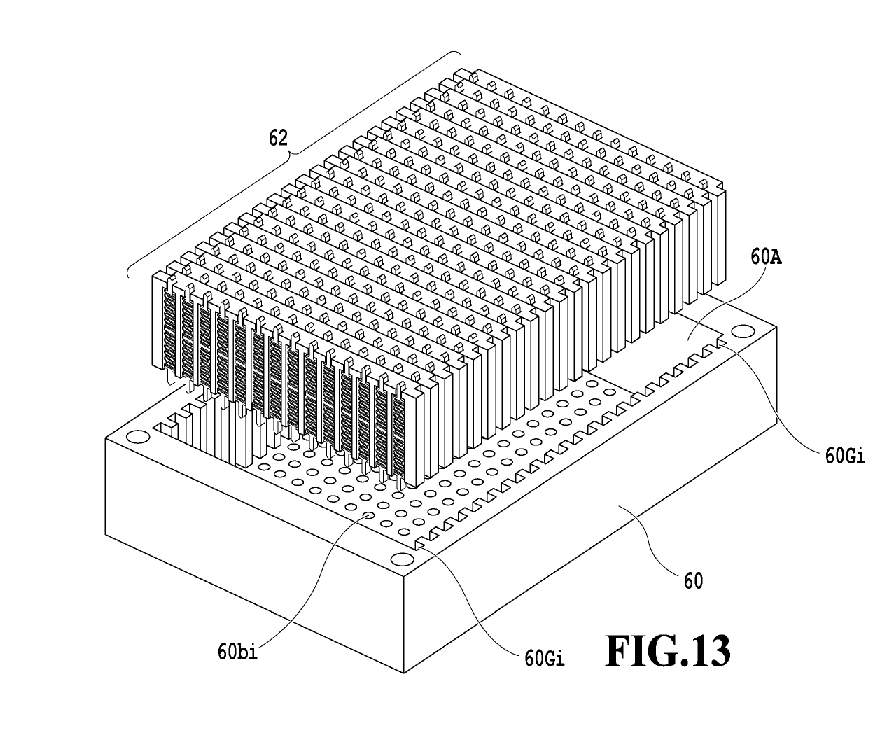

As shown in FIG. 13, the connection device comprises, as its main components: contact units including blades serving as contact supports to be described later, and a plurality of contact terminals; and a casing 60 provided with a contact unit accommodating portion 60A to accommodate a plurality of contact units.

The casing 60 is formed from a metal material, for example, and female screw holes 60a, into which machine screws are to be threaded via holes in the printed wiring boards, are provided at four corners of the casing 60. Moreover, as shown in FIG. 13, a plurality of holes 60bi (i=1 to n, n is a positive integer) are formed in a matrix and at predetermined intervals in a bottom wall portion that forms a bottom portion of the contact unit accommodating portion 60A. Contact portions of contact terminals 70ai to be described later are inserted into the holes 60bi. In addition, grooves 60Gi (i=1 to n, n is a positive integer) into which ends on both sides of respective blades to be described later are fitted, are formed at predetermined intervals in inner peripheral portions of two side walls of the casing 60 which extend in a longitudinal direction thereof. The adjacent grooves 60Gi are partitioned by partition walls.

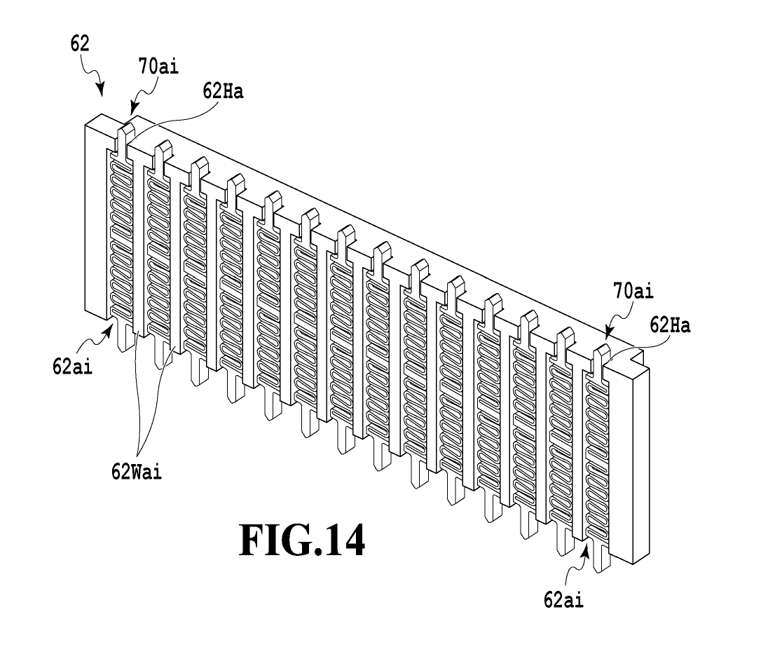

As shown in the enlarged view of FIG. 14, each contact unit comprises a plurality of signal and power-supply contact terminals 70ai (i=1 to n, n is a positive integer), and a blade 62 to accommodate the contact terminals 70ai into inner cells 62ai (i=1 to n, n is a positive integer), respectively.

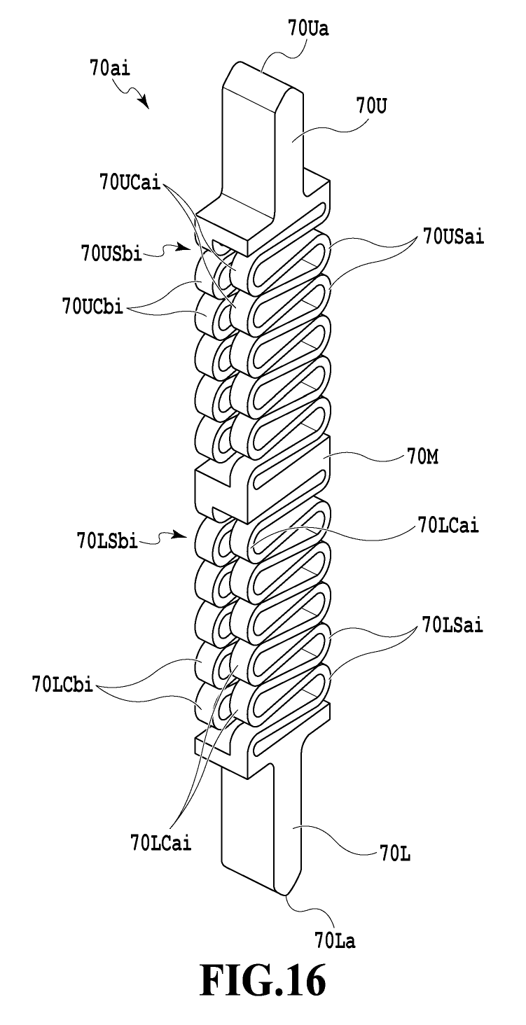

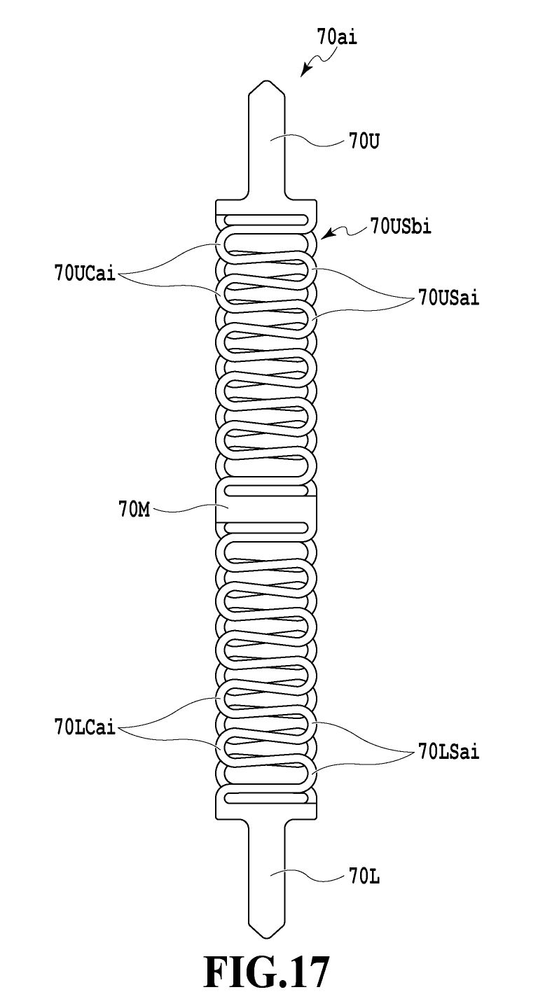

Each contact terminal 70ai representing a fifth embodiment of a contact terminal according to the present invention is formed of a conductive metal material by using the MEMS technique, for example. As shown in the enlarged view of FIGS. 16 and 17, the contact terminal 70ai comprises a first contact 70L to come into contact with the electrode CP1 of the printed wiring board PCB1, a second contact 70U to come into contact with an electrode of another printed wiring board opposed to the printed wiring board PCB1, and two columns of coupling portions to couple the first contact 70L to the second contact 70U such that the first contact 70L and the second contact 70U can move toward and away from each other.

The first contact 70L comprises: a movable piece provided with a cusped touching portion 70La that comes into contact with the electrode CP1 of the printed wiring board PCB1; and an extended portion formed at a proximal end of the movable piece and coupled to the coupling portions. One end of the extended portion is coupled to an end of a bend portion 70LSai of one of the coupling portions to be described later, and another end of the extended portion is coupled to an end of a bend portion 70LSbi of the other coupling portion to be described later.

The second contact 70U comprises: a movable piece provided with a cusped touching portion 70Ua that comes into contact with the electrode of the printed wiring board; and an extended portion formed at a proximal end of the movable piece and coupled to the coupling portions. One end of the extended portion is coupled to an end of a bend portion 70USai to be described later, and another end of the extended portion is coupled to an end of a bend portion 70USbi to be described later.

The two columns of the coupling portions are coupled to the extended portions of the first contact 70L and the second contact 70U while interposing an intermediate member 70M that is provided at an intermediate position between the first contact 70L and the second contact 70U.

In FIG. 16, a first coupling portion on the right column comprises: a plurality of bend portions 70USai (i=1 to n, n is a positive integer) that are convexly curved in such a way as to protrude rightward; a plurality of arcuate portions 20UCai (i=1 to n, n is a positive integer) each of which couples ends of the adjacent bend portions 70USai to each other or couples an end of the bend portion 70USai to the intermediate member 70M; a plurality of bend portions 70LSai (i=1 to n, n is a positive integer) that are convexly curved in such a way as to protrude rightward; and a plurality of arcuate portions 20LCai (i=1 to n, n is a positive integer) each of which couples ends of the adjacent bend portions 70LSai to each other or couples an end of the bend portion 70LSai to an end of the extended portion of the first contact 70L. One end of the intermediate member 70M is coupled to an end of the corresponding bend portion 70USai while another end of the intermediate member 70M is coupled to a connecting end connected to the arcuate portion 70LCai.

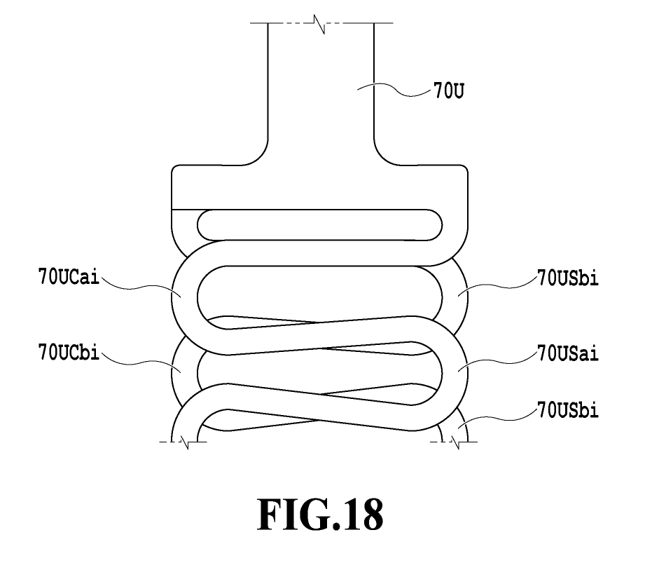

In FIG. 16, a second coupling portion on the left column comprises: a plurality of bend portions 70USbi (i=1 to n, n is a positive integer) (refer to FIG. 18) that are convexly curved in such a way as to protrude rightward; a plurality of arcuate portions 70UCbi (i=1 to n, n is a positive integer) each of which couples ends of the adjacent bend portions 70USbi to each other or couples an end of the bend portion 70USbi to an intermediate member 70M; a plurality of bend portions 70LSbi (i=1 to n, n is a positive integer) that are convexly curved in such a way as to protrude rightward; and a plurality of arcuate portions 70LCbi (i=1 to n, n is a positive integer) each of which couples ends of the adjacent bend portions 70LSbi to each other or couples an end of the bend portion 70LSbi to one end of the extended portion of the first contact 70L. One end of the intermediate member 70M is coupled to a connecting end connected to arcuate portions 70UCbi while another end of the intermediate member 70M is coupled to a connecting end of the bend portion 70LSbi.

Herewith, each of the first and second coupling portions is made expandable and contractible on the common plane in a moving direction of the first contact 70L and the second contact 70U.

Note that the two columns of coupling portions are formed integrally with the first contact and the second contact in the above-described example. However, the present invention is not limited to this example. For instance, the coupling portion may be formed in one column or the coupling portions may be formed in three or more columns.

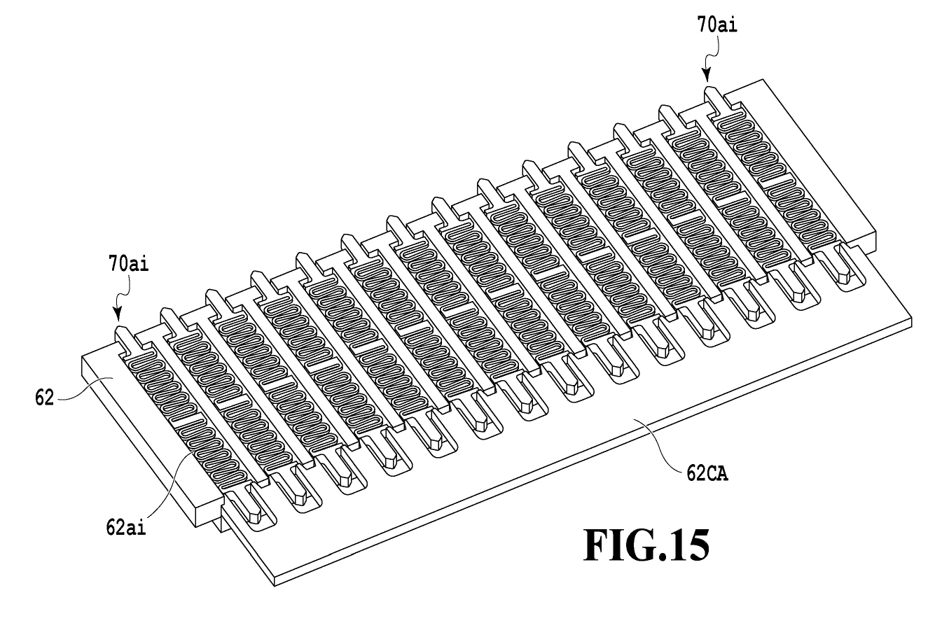

When the above-described contact terminals 70ai are the signal contact terminals, the blade 62 is formed into a thin plate by using a resin material, for example, as shown in the enlarged view of FIGS. 14 and 15. On the other hand, when the above-described contact terminals 70ai are the power-supply contact terminals, the blade 62 is formed into a thin plate by using a copper alloy or an aluminum alloy, for example. In the latter case, heat dissipation efficiency of the connection device can be improved since the casing 60 is also formed from the metal material.

Stepped projections to be fitted into the grooves 60Gi of the casing 60 described above are formed on both ends of each blade 62. A plurality of cells 62ai (i=1 to n, n is a positive integer) are formed at predetermined intervals in one surface of the blade 62. Another surface of the blade 62 is formed into a flat surface. On the one surface of the blade 62, the adjacent cells 62ai are partitioned therebetween by partition walls 62wai (i=1 to n, n is a positive integer) which are formed in parallel to one another. As shown in FIG. 14, one end of each partition wall 62wai crosses an upper edge portion of the blade 62. A hole 62Ha from which the second contact 70U inserted therein protrudes to the outside is formed corresponding to each cell 62ai. A lower end of each cell 62ai is open.

When each blade 62 is formed, the blade 62 is formed together with a carrier 62CA to be coupled to the partition walls 62wai as shown in FIG. 15. The carrier 62CA is cut off after the contact terminals 70ai are mounted to the cells 62ai.

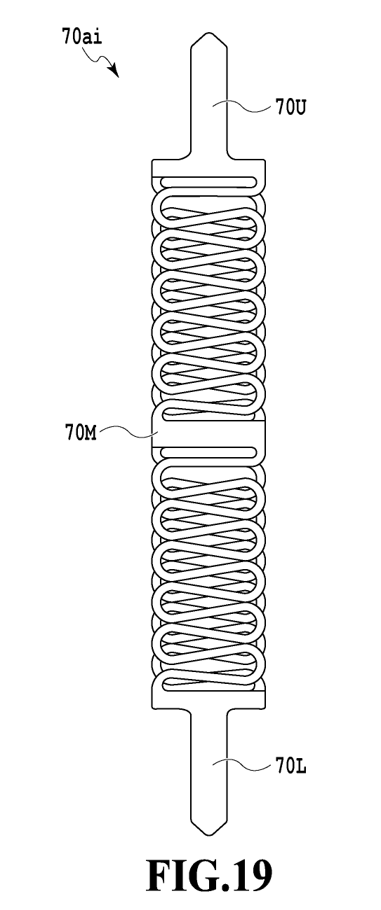

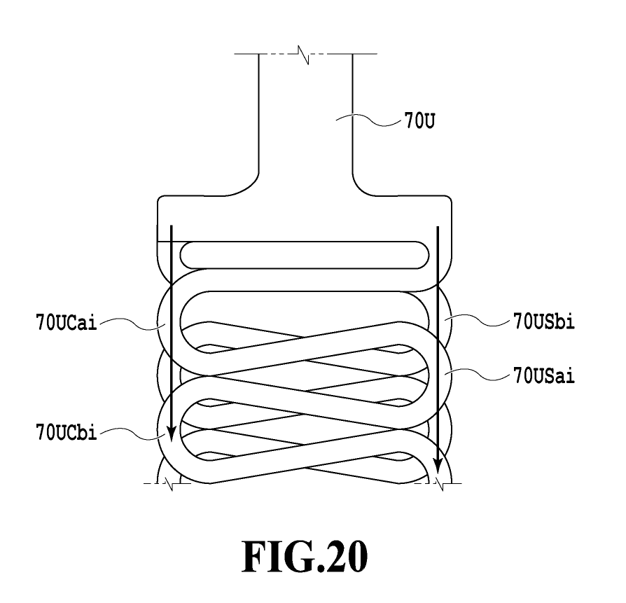

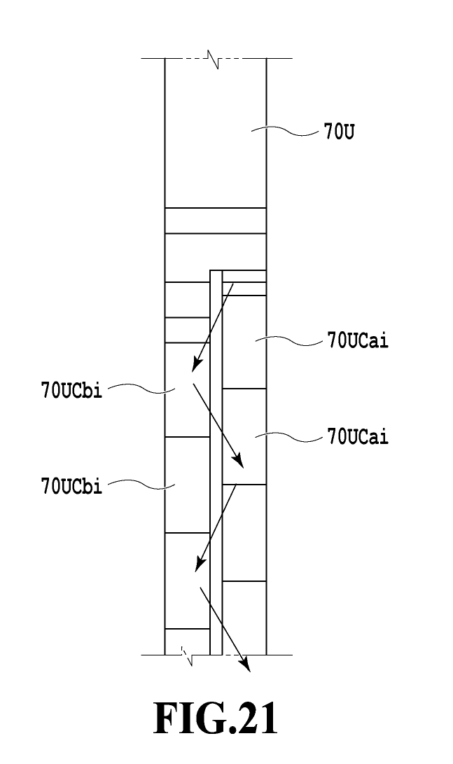

In the above-described configuration, the casing 60 to which the above-described contact units are fixed is located between the electrodes of the printed wiring boards opposed to each other. Thereafter, machine screws (not shown) are threaded into the female screw holes 60a provided in the casing 60, for example, via through-holes in the printed wiring boards. Thus, the first contact 70L and the second contact 70U of each contact terminal 70ai are moved closer to each other by a predetermined distance as shown in FIG. 19 while being pressed by the electrodes of the printed wiring boards against elastic force of the first and second coupling portions. Herewith, when the bend portions 70USai, 70USbi, 70LSai, and 70LSbi are deformed as shown in FIG. 20, clearances in each of the bend portions 70USai to 70LSbi and clearances between the adjacent bend portions 70USai to 70LSbi are reduced. Accordingly, when a signal at a high-frequency bandwidth is transmitted through these clearances as indicated with arrows, for example, a high-speed transmission characteristic is achieved without providing a vertically short-circuited structure. At that time, as shown in the enlarged view of FIG. 21, between the first coupling portion and the second coupling portion, because positions of the arcuate portions 70UCai are located close to positions of the arcuate portions 70UCbi, for example, the high-speed transmission characteristic is achieved as indicated with arrows therein even when the clearances are defined between the arcuate portion 70UCai and the extended portion. Moreover, each contact terminal 70ai is formed into a fine and relatively thin shape by using the conductive metal material and the MEMS technique. As a consequence, the contact terminals 70ai have no residual stress, and have excellent durability against repeated displacement.

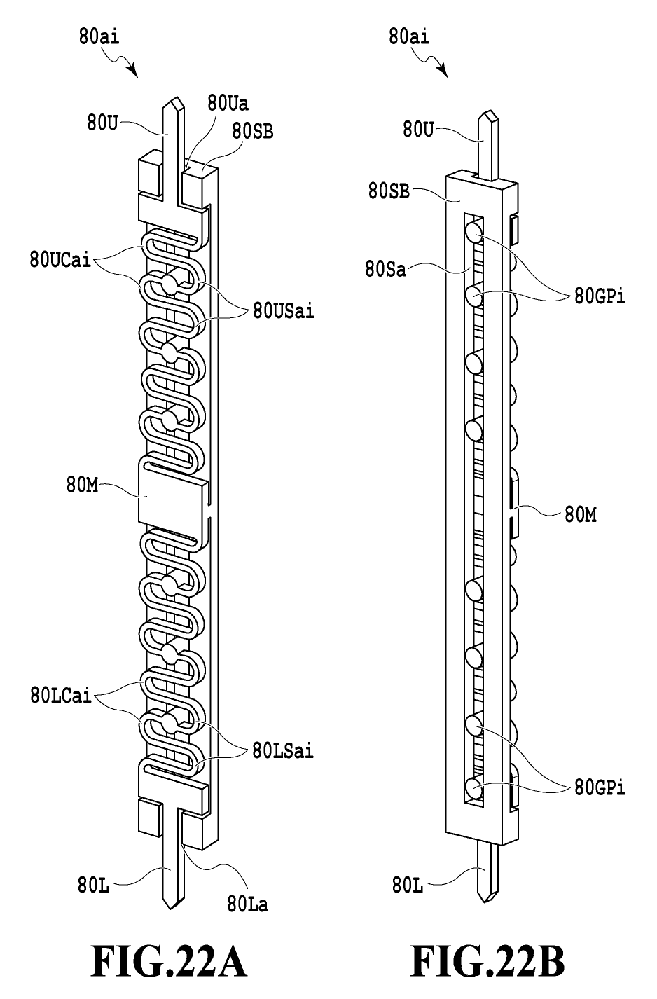

Furthermore, the contact unit is not limited to the above-described example. For instance, as shown in the enlarged view of FIGS. 22A and 22B, the contact unit may include signal and power-supply contact terminals 80ai (i=1 to n, n is a positive integer), and the blade 62 to house each contact terminal 80ai into each cell 62ai (i=1 to n, n is a positive integer) in the inside. The overlapping explanation on the blade 62 will be omitted.

Each contact terminal 80ai representing a sixth embodiment of a contact terminal according to the present invention is integrally formed of a conductive metal material by using the MEMS technique, for example. The contact terminal 80ai comprises, as its main components: a first contact 80L to come into contact with the electrode CP1 of the printed wiring board PCB1; a second contact 80U to come into contact with the electrode CP2 of the printed wiring board PCB2 opposed to the printed wiring board PCB1; a first coupling portion and a second coupling portion to couple the first contact 80L to the second contact 80U such that the first contact 80L and the second contact 80U can move toward and away from each other; an intermediate member 80M to couple an end of the first coupling portion to an end of the second coupling portion; and a support plate 80SB to support the first contact 80L, the second contact 80U, and the intermediate member 80M.

The first contact 80L comprises: a movable piece provided with a cusped touching portion 80La that comes into contact with the electrode CP1 of the printed wiring board PCB1; and an extended portion formed at a proximal end of the movable piece in a crossing manner and coupled to the first coupling portion. One end of the extended portion is coupled to an end of a bend portion 80LCai of the first coupling portion to be described later. The movable piece is movably inserted into a hole in a fix end formed integrally on one end of the support plate 80SB, and protrudes from the hole to the outside. The extended portion is biased by biasing force of the first coupling portion and is brought into contact with an inner surface of the fix end.

The second contact 80U comprises: a movable piece provided with a cusped touching portion 80Ua that comes into contact with an electrode of another printed wiring board; and an extended portion formed at a proximal end of the movable piece in a crossing manner and coupled to the second coupling portion. One end of the extended portion is coupled to a coupling end connected to arcuate portion 80UCai to be described later. The movable piece is movably inserted into a hole in a fix end formed integrally on another end of the support plate 80SB, and protrudes from the hole to the outside. The extended portion is biased by biasing force of the second coupling portion and is brought into contact with an inner surface of the fix end.

In FIG. 22A, the first coupling portion comprises: a plurality of bend portions 80LSai (i=1 to n, n is a positive integer) that are convexly curved in such a way as to protrude rightward; a plurality of arcuate portions 80LCai (i=1 to n, n is a positive integer) each of which couples ends of the adjacent bend portions 80LSai to each other or couples an end of the bend portion 80LSai to an end of the intermediate member 80M. The respective bend portions 80LSai are guided by guide pins 80GPi (i=1 to n, n is a positive integer) to be inserted into a guide elongate hole 80Sa in the support plate 80SB. The intermediate member 80M is formed integrally with the support plate 80SB.

In FIG. 22A, the second coupling portion comprises: a plurality of bend portions 80USai (i=1 to n, n is a positive integer) that are convexly curved in such a way as to protrude rightward; a plurality of arcuate portions 80UCai (i=1 to n, n is a positive integer) each of which couples ends of the adjacent bend portions 80USai to each other or couples an end of the bend portion 80USai to an another end of the intermediate member 80M. The respective bend portions 80USai are guided by guide pins 80GPi (i=1 to n, n is a positive integer) to be inserted into the guide elongate hole 80Sa in the support plate 80SB.

Herewith, the first coupling portion and the second coupling portion are made expandable and contractible in a moving direction of the first contact 80L and the second contact 80U on the common plane while retaining a predetermined clearance with a surface of the support plate 80SB, respectively.

In the above-described configuration, the casing 60 to which the above-described contact units are fixed is located between the electrodes of the printed wiring boards opposed to each other. Thereafter, the machine screws (not shown) are threaded into the female screw holes 60a provided in the casing 60, for example, via through-holes in the printed wiring boards. Thus, the first contact 80L and the second contact 80U of each contact terminal 80ai are moved closer to each other by a predetermined distance while being pressed by the electrodes of the printed wiring boards against the elastic force of the first and second coupling portions. Hereby, a signal is transmitted through the first contact 80L, the support plate 80SB, and the second contact 80U with the guide pins 80GPi being guided by the guide elongate hole 80Sa. Accordingly, when a signal at a high-frequency bandwidth is transmitted through these clearances, for example, a high-speed transmission characteristic is achieved, and inductance of a signal path is reduced at the same time. Moreover, each contact terminal 80ai is formed into a fine and relatively thin shape by using the conductive metal material and the MEMS technique. As a consequence, the contact terminals 80ai have no residual stress, and have excellent durability against repeated displacement.

In each of the above-described embodiments, the board-to-board connector is applied to the example of the connection device according to the present invention. However, the present invention is not limited to this example. For instance, it is needless to say that the present invention is also applicable to other devices such as an IC socket to electrically connect a semiconductor device to a circuit board, and a cable connector to electrically connect an end of a cable to a circuit board.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A contact terminal comprising:
a first movable contact and a second movable contact movably provided while being opposed to each other on a common axial line, the contacts being configured to come into contact with electrodes of boards, respectively;
an intermediate member provided between the first movable contact and the second movable contact;
a first coupling portion including a plurality of elastically deformable bend portions connected along the axial line and configured to couple the first movable contact to one end of the intermediate member; and
a second coupling portion including a plurality of elastically deformable bend portions connected along the axial line and configured to couple the second movable contact to another end of the intermediate member,
the first movable contact, the second movable contact, the intermediate member, the first coupling portion, and the second coupling portion being provided integrally with one another, wherein
when the first movable contact and the second movable contact are pressed so as to come closer to each other, a signal path is formed linearly between the first movable contact and the second movable contact by bringing the adjacent bend portions of the first coupling portion and the second coupling portion close to one another.

2. The contact terminal according to claim 1, wherein the first coupling portion and the second coupling portion are formed in two lines parallel to each other between the first movable contact and the second movable contact by using an MEMS technique.

3. The contact terminal according to claim 1, further comprising:
guide pins provided to the first coupling portion and the second coupling portion; and
a support plate configured to guide the first movable contact and the second movable contact through the guide pins.

4. The contact terminal according to claim 1, wherein a contact sheet including a plurality of the contact terminals is formed by coupling a plurality of the intermediate members to each other in a straight line through a coupling piece.

5. A contact terminal comprising:
a first movable contact and a second movable contact movably provided while being opposed to each other on a common axial line, the contacts being configured to come into contact with electrodes of boards, respectively;
a pair of coupling portions each including a plurality of elastically deformable bend portions connected along the axial line, and configured to couple the first movable contact to the second movable contact such that the first and second movable contacts are movable toward and away from each other;
a first short-circuit piece extending from an end of the first movable contact toward the second movable contact; and
a second short-circuit piece extending from an end of the second movable contact toward the first movable contact,
the first movable contact, the second movable contact, the coupling portions, the first short-circuit piece, and the second short-circuit piece being provided integrally with one another, wherein
when the first movable contact and the second movable contact are pressed so as to come closer to each other, a signal path is formed by the first movable contact, the second movable contact, the first short-circuit piece, and the second short-circuit piece by bringing the first short-circuit piece and the second short-circuit piece into contact with each other.

6. The contact terminal according to claim 5, wherein an arc-shaped touching portion of the first movable contact and an arc-shaped touching portion of the second movable contact are located opposite from each other on a straight line crossing and being inclined from the common axial line.

7. A contact terminal comprising:
a first movable contact and a second movable contact movably provided while being opposed to each other on a common axial line, the contacts being configured to come into contact with electrodes of boards, respectively;
a first coupling portion including a plurality of elastically deformable bend portions connected along the axial line, and configured to couple the first movable contact to a first portion of a short-circuit piece opposed to the bend portions; and
a second coupling portion including a plurality of elastically deformable bend portions connected along the axial line, and configured to couple the second movable contact to a second portion of the short-circuit piece opposed to the bend portions,
the first movable contact, the second movable contact, the first coupling portion, and the second coupling portion being provided integrally with one another, wherein
when the first movable contact and the second movable contact are pressed so as to come closer to each other, a signal path is formed by the first movable contact, the second movable contact, and the short-circuit piece by bringing the short-circuit piece, any of the bend portions of the first coupling portion, and any of the bend portions of the second coupling portion into contact with one another.

8. A contact support comprising:
a cell configured to individually accommodate the contact terminal according to claim 1.

9. A contact support comprising:
a plurality of recesses provided in one surface of the contact support and each configured to accommodate the contact terminal according to claim 5; and
a plurality of recesses provided in another surface of the contact support opposite from the one surface and each configured to accommodate a contact terminal having a different shape from a shape of the former contact terminal.

10. A contact support comprising:
a plurality of recesses provided in one surface of the contact support and each configured to accommodate the contact terminal according to claim 7; and
a plurality of recesses provided in another surface of the contact support opposite from the one surface and each configured to accommodate a contact terminal having a different shape from a shape of the former contact terminal.

11. A connection device comprising:
a plurality of the contact terminals;
a plurality of the contact supports according to claim 8; and
a casing formed of a metal material and configured to accommodate the plurality of the contact supports.

12. A connection device comprising:
a plurality of the contact terminals;
a plurality of the contact supports according to claim 9; and
a casing formed of a metal material and configured to accommodate the plurality of the contact supports.

13. A connection device comprising:
a plurality of the contact terminals;
a plurality of the contact supports according to claim 10; and
a casing formed of a metal material and configured to accommodate the plurality of the contact supports.
